(19) United States
(12) Patent Application Publication
(10) Pub. No.: US 2010/0238110 A1
(43) Pub. Date: Sep. 23, 2010

(54) LOCOMOTION INTERFACE DEVICE FOR INVOLVING BIPEDAL MOVEMENT IN CONTROL OVER COMPUTER OR VIDEO MEDIA

(75) Inventors: Marina Prushinskaya, Farmington Hills, MI (US); Leonid Kaplan, Farmington, MI (US)

Correspondence Address: BROOKS KUSHMAN P.C., 1000 TOWN CENTER, TWENTY-SECOND FLOOR, SOUTHFIELD, MI, 48075, US

(73) Assignee: VIRTUAL PRODUCTS, LLC, Ann Arbor, MI (US)

(21) Appl. No.: 12/741,712

(22) PCT Filed: Nov. 7, 2008
(86) PCT No.: PCT/US08/82817

§ 371 Date: May 6, 2010

Related U.S. Application Data
(60) Provisional application No. 61/002,225, filed on Nov. 7, 2007.

(51) Int. Cl. G09G 5/00

(52) U.S. Cl. 345/156

(57) ABSTRACT

A locomotion interface includes a first section for a user contact with lower extremities and a second section proximate to the first section. The second section includes a first action region for the user to contact and move a lower extremity over. The locomotion interface also includes a first plurality of sensors for detecting this motion in the vicinity of the first action region. The locomotion interface typically includes a second action region and a second plurality of sensors. During operation the user contacts and moves a lower extremity over the second action region. The second plurality of sensors is positioned to detect this motion in the vicinity of the second action region.

### CROSS-REFERENCE TO RELATED APPLICATIONS

This application claims the benefit of U.S. provisional application Ser. No. 61/002,225 filed Nov. 7, 2007.

### BACKGROUND OF THE INVENTION

1. Field of the Invention

The present invention is related to methods and interfaces for inputting locomotion information into an interactive electronic device.

2. Background Art

Electronic interactive devices such as video game consoles strive to provide better interfaces to simulate real life activities such as swinging a baseball bat, throwing a football, and the like. Moreover, computer technology will undoubtedly advantage to provide improved 3D simulation is a virtual reality environment.

Currently, interface technology includes the well-known joystick, which is able to provide input to an electronic interactive device to simulate movement (i.e., up, down, left, right). The use of a joystick to simulate walking motion of a character in such interactive devices tends to be somewhat unnatural because hand motion is being used to simulate activities done by the lower extremities.

More advanced interfaces attempt to simulate real world activities in a more natural manner. For example, interfaces deploying a steering wheel are used for driving simulations. Recently hand held devices have advanced to a sufficient degree to simulate hand motions involving swinging. Foot operable interface to provide dance simulation have also recently appeared.

Although these interface device work reasonable well, there are very few devices that simulated walking in a nature manner.

Accordingly, there is a need for improved methods and devices for simulating walking motion by a user.

### SUMMARY OF THE INVENTION

The present invention overcomes the problems encountered in the prior art by providing in one embodiment a locomotion interface for generating an output signal that is provided to an interactive electronic device. The provided signal is inputted to and used by the interactive electronic device to simulate motion (e.g., walking and running motion). The locomotion interface includes a first section to be contacted by the lower extremities of a user and a second section proximate to and upwardly included relative to the first section. The second section includes a first action region for the user to contact and move a lower extremity over. The locomotion interface also includes a first plurality of sensors for detecting motion of the user's extremities in the vicinity of the first action region. The locomotion interface typically includes a second action region and a second plurality of sensors located in the second section. During operation the user contacts and moves a lower extremity over the second action region. The second plurality of sensors is positioned to detect this motion in the vicinity of the second action region.

### BRIEF DESCRIPTION OF THE DRAWINGS

FIG. 1 is a schematic illustration of the utilization of an embodiment of a locomotion interface;

FIG. 2A is a schematic top view of an embodiment of a locomotion interface:

FIG. 2B is a schematic illustration showing the placement of switches in the locomotion interface of FIG. 2A;

FIG. 3 is a schematic top view of a variation having action regions associated with backward motion;

FIG. 4 is a schematic top view of a locomotion pad for simultaneous use by two users; and

FIG. 5 is a pictorial flow chart illustrating alternating activation of action regions to provide input. to an interactive electronic device.

### DETAILED DESCRIPTION OF THE PREFERRED EMBODIMENT(S)

Reference will now be made in detail to presently preferred compositions or embodiments and methods of the invention, which constitute the best modes of practicing the invention presently known to the inventors.

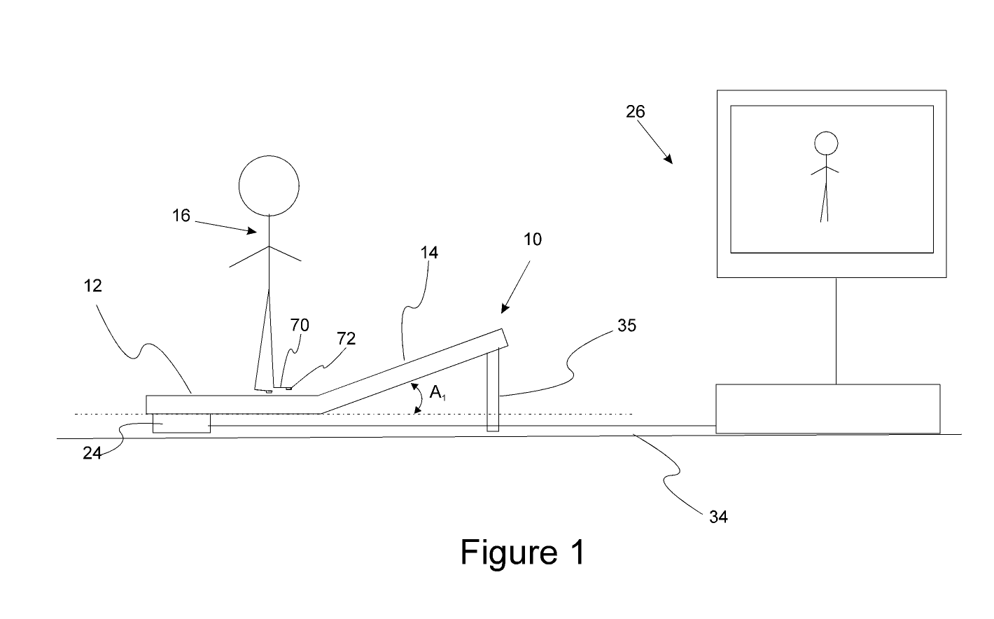

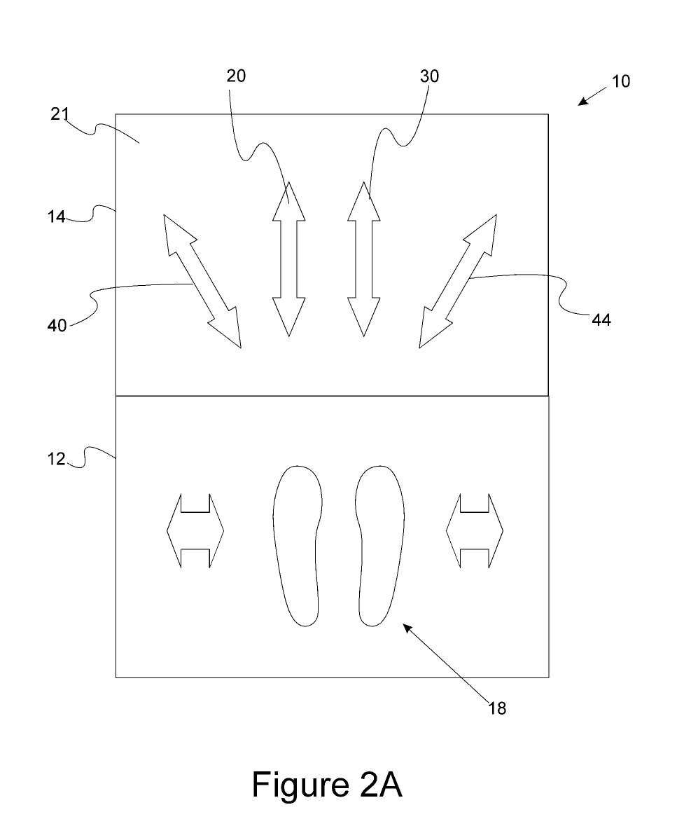

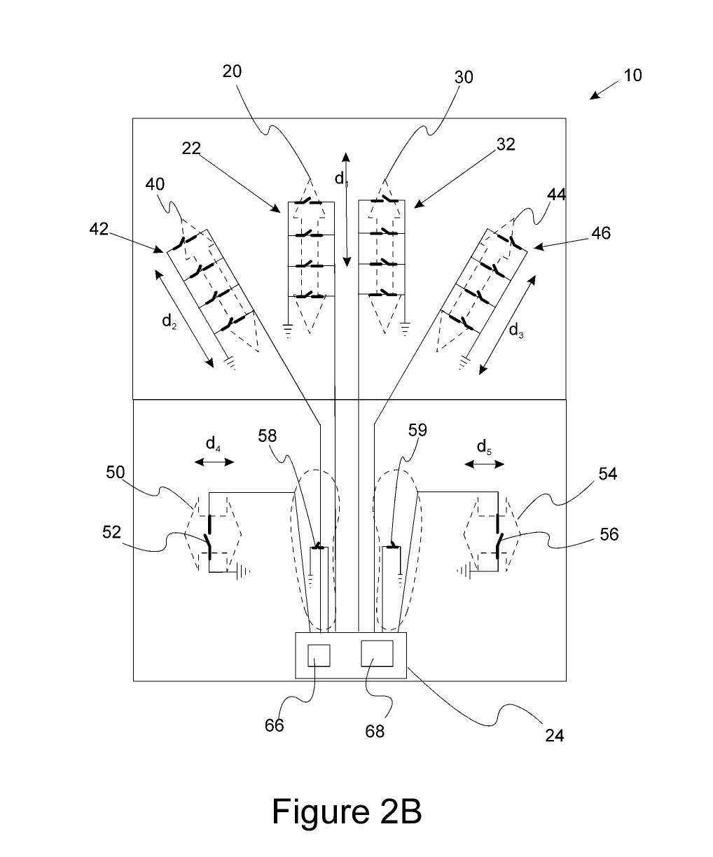

With reference to FIGS. 1, 2A and 2B, schematic illustrations of a locomotion interface for generating an output signal related to motion by a user is provided. Locomotion interface 10 includes first section 12 and second section 14. First section 12 is designed for user 16 to stand on. Specifically, the user stands at position 18. In another refinement, user 16 is seated while contacting position 18. Second section 14 is positioned proximate to first section 12. Second section 14 is inclined upward relative to first section 12. In a refinement, one or both of first section 12 and second section 14 are substantially planar. In another refinement, one or both of first section 12 and second section 14 are concave upward or concave downward. Second section 14 includes first action region 20 for the user to move a lower extremity over to simulate walking. “Action region” as used in this context means a region on surface 21 over which user 16 is to slide a foot. Locomotion device 10 further includes first plurality of sensors 22 for detecting motion in the vicinity of first action region 20. Activation of one or more sensors is detected by signal processor 24, which is adapted output a signal to interactive electronic device 26. Suitable examples of interactive electronic devices include, but are not limited to, computer or video game; virtual environment; computerized board games, and the like. Applications executing on such devices that may advantageously utilize the locomotion interface of the present invention include, but are not limited to, computer software using cursor movement or menu selection; TV menu selection; computerized or video tours; cell phone game or menu selection; and combinations thereof. In a variation, plurality of sensors 22, 32 are positioned on the opposite side to surface 21 (i.e., on the bottom side).

Still referring to FIGS. 1, 2A, and 2B, in a variation of the present embodiment locomotion interface 10 further includes second action region 30 and second plurality of sensors 32 for detecting motion in the vicinity of second action region 30. In a refinement, first plurality of sensors 22 is position to detect motion from a user's right lower extremity and second plurality of sensors 32 is positioned to detect motion from the user's left lower extremity. Typically, plurality of sensors 22, 32 is independently longitudinally distributed along direction d1, which extend away from first section 12. In a refinement, the distribution of sensors 22, 32 may be slightly angled. Activation of sensors 22, 32 is usually accomplished by sliding a foot over action regions 20, 30. Signals outputted from plurality of sensors 22, 32 are utilized by interactive electronic device 26 to simulate forward motion (i.e., walking forward).

Second section 14 is angled with respect to surface 34 upon which locomotion interface 10 is placed. Second section 14 is angled to provide a comfortable feel to the user while walking motion is being simulated. Pedestal 35 accomplishes the angling. In particular, second section 14 is angled with respect to section 12. In a refinement, second section 14 is inclined at an angle from 15 to 25 degrees with respect to first section 12 and/or surface 34.

Referring now to FIG. 2B, plurality of sensors are depicted as communicating with signal processor 24 via a single input. In a variation, each sensor may individually communicate with signal processor 24. In either variation, the number of sensors activated in either plurality of sensors 22 or 32 may provide a measure of the step size a user takes (i.e., the more sensors activated the longer the step size). Moreover, in a refinement, the timing between activation of the sensors is utilized to provide a measure of speed for the simulated locomotion.

In another variation of the present embodiment, locomotion interface 10 also includes third action region 40 which is associated with sensor(s) 42 and fourth action regions 44 which is associated with sensor(s) 46. Third and fourth action regions 40, 44 in combinations with sensor(s) 42 and 46 are used to output signals that are to be interpreted as turning left or right. This is accomplished by a user sliding a foot over action regions 40, 44 along respective directions d2 and d3. In this variation, each of sensor(s) 42 and 46 may be a single sensor.

It should be further appreciated that locomotion interface 10 may include additional action regions. For example, FIG. 2A and 2B depicts a variation which also includes action region 50 which is associated with sensor(s) 52 and action region 54 which is associated with action region 56. In this example, sensor(s) 52, 56 output signals to be interpreted as moving sideways to the left and right. Optionally, locomotion interface 10 includes sensors 58, 59, which sense when the user is standing on position 18. This sensors may also be used detect jumping and weight shifting movements.

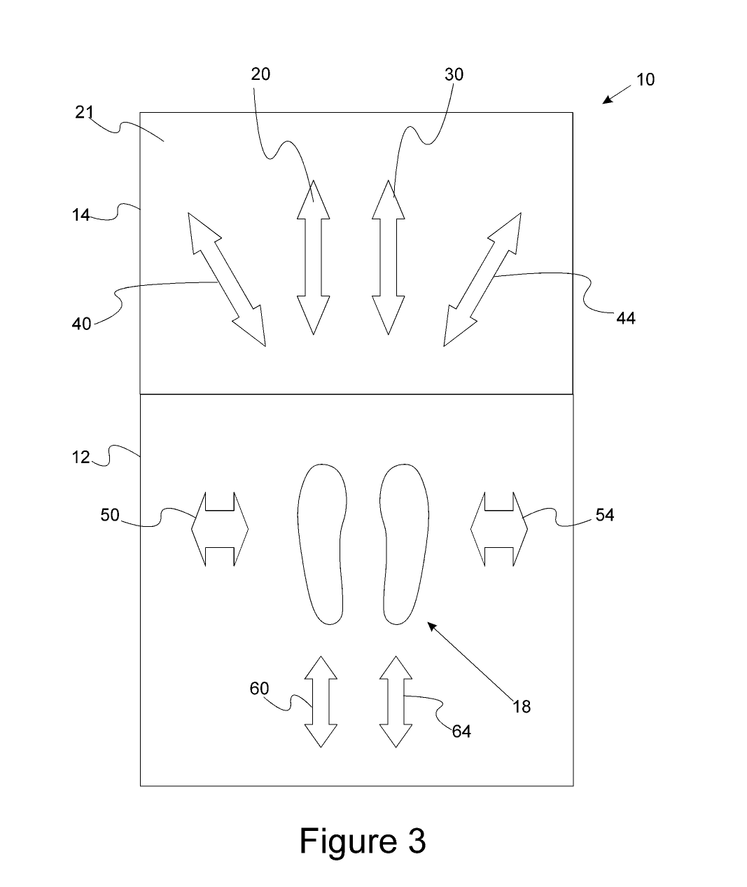

With reference to FIG. 3, a schematic top view of a variation of the present embodiment have action regions associated with backward motion is provided. In this variation, locomotion interface 10 includes action regions 60, 64 over which a user slides a foot to simulate rearward motion (i.e., walking or running backwards). Each of action regions 60, 64 has associated sensor(s) as set forth above.

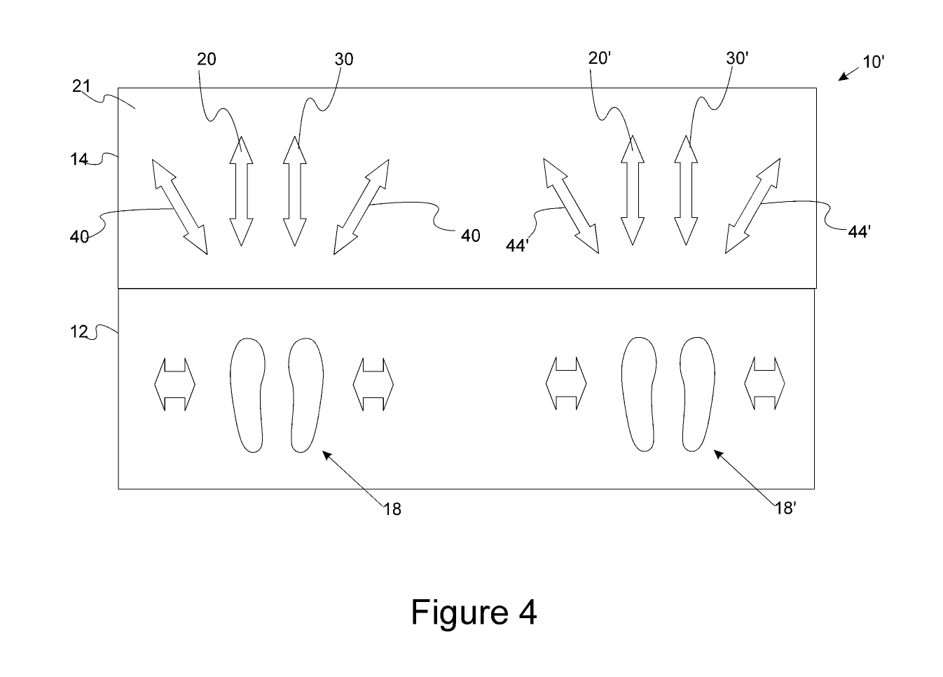

With reference to FIG. 4, a schematic top view of a variation of a locomotion pad for user by two users is provided. In this variation, locomotion interface 10′ includes first section 12 and second section 14. First section 12 is designed for a first user to stand at position 18 and a second user to stand at position 18′. Second section 14 is positioned proximate to first section 12. Second section 14 includes first action regions 20, 30 for the first user to move a lower extremity over to simulate walking and regions 20′, 30′ for the second user to move a lower extremity over to simulate walking. Locomotion interface 10′ also includes action regions 40, 44, which are used by the first user to output signals that are to be interpreted as turning left or right and action regions 40′, 44′ which are used by the second user to output signals that are to be interpreted as turning left or right.

As set forth above, user motion is detected by strategic location of plurality of sensors 22, 24, sensor(s) 42, 46, and sensor(s) 52, 56. These sensors may operate by a variety of mechanisms—sensing a position, a direction of movement, or a pace of movement of user's lower extremities. Moreover, such sensor can detect motions that include walking, running, jumping, shifting, turning, crouching, moving the lower extremities while sitting or laying, strafing, or combinations thereof. Examples of suitable sensors for this application include, but are not limited to, pressure sensors, motion sensors, video sensors, photosensitive sensors, magnetic induction sensors, acoustic sensors, infrared sensors, ultraviolet sensors, reed sensors, electric sensors, electromagnetic sensors, capacity sensors, or combination thereof. In a refinement, plurality of sensors 22, 24, sensor(s) 42, 46, and sensor(s) 52, 56 are operable to detect a magnetic field generated by a magnet attached to or carried by the user's lower extremities. Reed switches are particular useful for these refinement. Reed switches are activated by permanent magnets. This allows the Reed switch to be located on a bottom surface of locomotion interface 10. Referring to FIG. 1, when Reed switches are used, user 16 must wear footwear 70 that has permanent magnets 72 contained therein.

With reference to FIGS. 2A, 2B, and 3, locomotion interfaces 10 and 10′ include signal processor 24, which converts activation of sensor to a signal that is inputted to interactive electronic devices. In a refinement, signal processor includes encoder 66, which converts activation of sensors to a digital signal. In addition to encoder 66, signal processor 24 optionally includes additional processing circuits 68 that transform the signal in a suitable form for input to electronic device 26. Keyboard encoders and emulators may be used for signal processor 24. Suitable encoders and emulators include the SmartWye™ and the SmartAe™ Series of USB & PS/2 PC Keyboard Encoders commercially available from Vetra Systems Corporation and the KE line of keyboard controllers commercially available from Hagstrom Electronics, Inc. In one variation, such circuits add a delay so that a signal persists for a time after actuation of a sensor is completed. Such delays enhance the smoothness of the interaction between locomotion interfaces and the interactive interfaces set forth above.

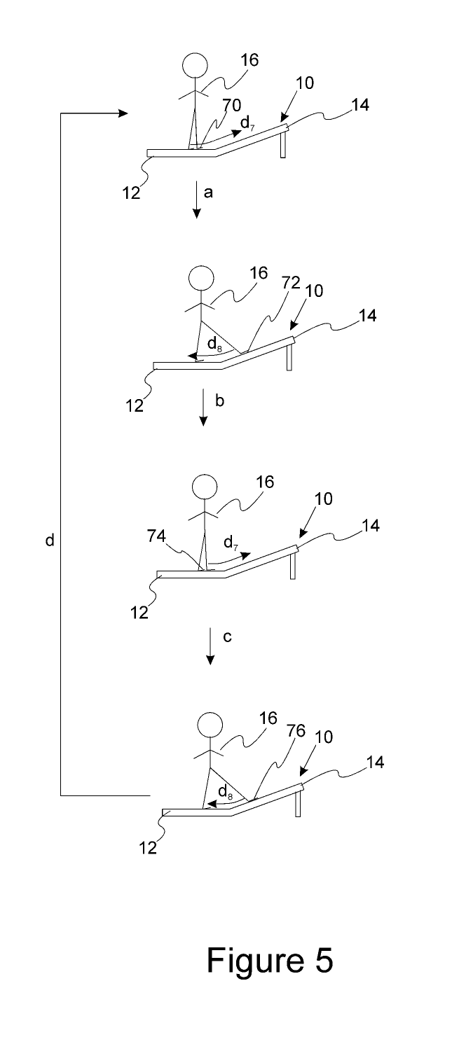

With reference to FIGS. 2A, 2B, and 5, illustration of alternating activation of plurality of switches 20 and 30 is provided. FIG. 5 is a pictorial flow chart illustrating this alternating activation. In step a), user 16 moves right foot 70 up to position 72 on second section 14 of locomotion interface 10. Typically, the user will not contact locomotion interface 10 while moving right foot 70 to position 72. In step b), user 16 slides his foot down section 14 along direction d8 while contacting action region 30 in section 14. This will activate one or more sensors in plurality of sensors 32. In step c), user 16 move left foot 74 up to position 76 on second section 14 of locomotion interface 10. Typically, the user will not contact locomotion interface 10 while moving left foot 74 to position 76. In step b), user 16 slides his foot down section 14 along direction d8 while contacting action region 20 in section 14. This will activate one or more sensors in plurality of sensors 22. The motion of steps a-d is repeated any number of times. The alternating activation of plurality of sensors 22 and plurality of sensors 32 is sensed by signal processor 24. Signal processor 24 than outputs control signals to an interactive electronic device to represent forward motion in that device.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A locomotion interface for generating an output signal related to motion by a user, the interface comprising:
a first section to be contacted by extremities of a user;
a second section proximate to and inclined upward relative to the first section, the second section including a first action region for the user to move a lower extremity over; and
a first plurality of sensors for detecting motion of one of the user's extremities in the vicinity of the first action region.

2. The locomotion interface of claim 1 further comprising a second action region and a second plurality of sensors for detecting motion located in the second section, the second plurality of sensors positioned to detect motion in the vicinity of the second action region.

3. The locomotion interface of claim 2 wherein the first plurality of sensors is positioned to detect motion from a user's right lower extremity and the second plurality of sensors is positioned to detect motion from the user's left lower extremity.

4. The locomotion interface of claim 1 wherein the second section is inclined at an angle from about 15 to 25 degrees relative to the first section.

5. The locomotion interface of claim 1 further comprising a signal processor for converting output from the sensors to a signal that is received by an interactive electronic device.

6. The locomotion of claim 5 wherein the interactive electronic device is a microprocessor-based device.

7. The locomotion of claim 5 wherein the interactive electronic device is a video game console.

8. The locomotion of claim 5 wherein the interactive electronic device is a computer

9. The locomotion device of claim 1 wherein the first plurality of sensors detect walking and running.

10. The locomotion device of claim 1 further comprising a rear action region for detecting backward motion.

11. The locomotion device of claim 1 wherein the first and second sections are substantially planar.

12. The locomotion device of claim 1 wherein one or both of the first and second sections are concaved.

13. The locomotion device of claim 1 further comprising a side action region for detecting sideways motion.

14. The locomotion device of claim 1 wherein the first plurality of sensors are operable to detect a magnetic field generated by magnet carried by the user's lower extremities.

15. A locomotion interface for generating an output signal related to motion by a user, the interface comprising:
a first section to be contacted by extremities of a user;
a second section proximate to and inclined upward relative to the first section, the second section including a first action region for the user to move a right foot over and a second action region for a user to move a left foot over; and
a first plurality of sensors for detecting motion of the right foot in the vicinity of the first action region; and
a second plurality of sensors for detecting motion of the left foot in the vicinity of the second action region.

16. The locomotion interface of claim 15 further comprising a signal processor for converting output from the sensors to a signal that is received by an interactive electronic device.

17. The locomotion device of claim 15 wherein the first and second plurality of sensors are operable to detect a magnetic field generated by magnet carried by the user's lower extremities.
